(19) United States
(12) Patent Application Publication
(10) Pub. No.: US 2019/0146498 A1
(43) Pub. Date: May 16, 2019

(54) METHODS AND SYSTEMS FOR VEHICLE MOTION PLANNING

(71) Applicant: Faraday&Future Inc., Gardena, CA (US)

(72) Inventors: Avinash Balachandran, Sunnyvale, CA (US); Christopher Jung-Kit Ho, San Francisco, CA (US)

(21) Appl. No.: 15/898,222

(22) Filed: Feb. 15, 2018

Related U.S. Application Data
(60) Provisional application No. 62/460,054, filed on Feb. 16, 2017.

(51) Int. Cl. G05D 1/00; G05D 1/02; G06N 7/08; G05B 13/04; G06F 17/11; G06Q 10/04

(52) U.S. Cl. CPC G05D 1/0088; G05D 1/0223; G06N 7/08; G05D 2201/0213; G06F 17/11; G06Q 10/047; G05B 13/041

(57) ABSTRACT

Motion planning is described herein. Motion planning includes determining one or more trajectories and/or velocities. Trajectories and velocities are then provided to one or more controllers that cause a vehicle to travel to a location. By dynamically determining a motion path with various math equations, time may be saved by eliminating the need to choose between a plurality of motion plans.

### CROSS-REFERENCE TO RELATED APPLICATIONS

This application claims the benefit of U.S. Provisional Application No. 60/460,054, filed Feb. 16, 2017, the entirety of which is hereby incorporated by reference.

### FIELD OF THE DISCLOSURE

This relates generally to automated driving and driving assistance systems, and more particularly, to motion planning.

### BACKGROUND OF THE DISCLOSURE

Modern vehicles, especially automobiles, increasingly provide automated driving and driving assistance systems such as adaptive cruise control, automatic parking, and automatic navigation. Motion planning is often used to accomplish these tasks. Motion planning includes determining one or more trajectories and/or velocities. Trajectories and velocities are then provided to one or more controllers that cause a vehicle to travel to a location.

### BRIEF DESCRIPTION OF THE DRAWINGS

FIG. 1 illustrates an example diagram including a vehicle, an obstacle, and a goal, according to examples of the disclosure.

FIG. 2 illustrates an example diagram including a vehicle, an obstacle, and a goal, according to examples of the disclosure.

FIG. 3 illustrates an example process for motion planning, according to examples of the disclosure.

FIG. 4 illustrates an example diagram of a vehicle polygon, according to examples of the disclosure.

FIG. 5 illustrates an exemplary system block diagram of an autonomous vehicle system including automated driving software according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Modern vehicles, especially automobiles, increasingly provide automated driving and driving assistance systems such as automatic parking and automatic navigation. To accomplish these tasks, motion planning methods typically determine a path for a vehicle. Motion planning methods often incorporate searching for a path to follow, avoiding obstacles and generating the best trajectory that ensures safety, comfort, and efficiency. As described herein, a motion planner (e.g., one or more systems capable of motion planning, which may include a sequence of poses, velocities, trajectories, or a combination thereof) can use information from a map (e.g., a Highly Automated Driving map (HAD map), also known as an HD map), sensors, a database, a knowledge graph, and/or a decision maker to generate a trajectory and/or velocity to be used by a vehicle to move the vehicle to a desired location. In some embodiments, a decision maker is a system that determines a target location/pose for a vehicle (e.g., a location/pose where an automated driving system intends to move a vehicle, such as a parking space, a position behind a vehicle directly in front of the autonomous vehicle, or a location provided by the user of a mobile application). Herein, a pose refers to a location and orientation of a vehicle. Further, herein, a trajectory may include a series of waypoints, a series of poses, one or more wheel angles, and/or other vehicle characteristics.

A motion planner, as described herein, can operate without the need for searching through a plurality of paths (e.g., via a tree traversal or other search algorithm). In embodiments described herein, the motion planner implicitly handles obstacles, without generating a plurality of trajectories and searching through them. For example, the motion planner may continually optimize trajectories and/or velocities to find one or more optimal trajectories and/or velocities. In some embodiments, convexifying the input provided by a sensors and/or a decision maker (e.g., setting up a problem based on obstacles, a target location, etc. and convexifying the problem so it may be solved by finding a maximum or minimum) may be performed by a motion planner. In some embodiments, the motion planner may output the optimal trajectory and/or velocity. In other words, after receiving a set of inputs, an optimization is ran by a motion planner, and the motion planner outputs a trajectory and/or velocity (as opposed to the motion planner choosing between a plurality of trajectories and/or velocities and outputting one or more of the trajectories and/or velocities). In some embodiments, the trajectory and/or velocity output by the motion planner may include a sequence of trajectory points (e.g., waypoints) for a pre-determined time horizon (e.g., an amount of time for which an autonomous vehicle, decision maker, and/or motion planner is using). In some embodiments, trajectory points may include easting, northing, and/or heading (e.g., as global coordinates), a desired velocity, a desired acceleration, and a desired curvature and/or steering angle.

In embodiments described herein, a motion planner receives input including right lane and left lane boundaries from a map and/or a perception system (e.g., sensors used for perceiving an environment around a vehicle (e.g., ultrasonic sensors, video, LiDAR, radar, etc.)). A motion planner may also receive input that includes obstacles (also referred to as obstacle polygons) from a perception system. In some embodiments, a motion planner may receive input associated with how an obstacle moves over time. Such input may be provided by a prediction engine, which can predict a location of a moving object at a particular time. Other inputs include a speed limit associated with the road a vehicle is on (which may be provided by a map), and a goal location (which may be provided by a decision maker).

Goals of a motion planner can include lane keeping, adaptive cruise control and stop and go, obstacle avoidance, and comfortable riding. In some embodiments, lane keeping includes a motion planner obtaining lane boundary information from the map and/or perception system and generating a trajectory and/or velocity to keep a vehicle in its lane. In some embodiments, adaptive cruise control and “stop and go” includes a motion planner providing a trajectory and/or velocity which can be used to cause a vehicle to maintain a speed while following a vehicle, cause a vehicle to maintain a speed limit, and/or cause a vehicle to come to a stop and/or begin moving (e.g., stop and go). In some embodiments, obstacle avoidance includes a motion planner receiving obstacles (e.g., obstacle polygons that represent vehicles, pedestrians, bicyclists) from a perception system and incorporating them into the motion planning (e.g., performed by the motion planner) to stop and/or maneuver around the obstacle based on a variety of factors including, but not limited to: the size of the obstacle, the movement of the obstacle, lane boundary information, etc. In addition, in some embodiments, comfortable riding refers to the generation of a trajectory and/or velocity that provides for increased passenger comfort when compared to alternative trajectories and/or velocities.

Some of the contributions of the motion planner are the formulation and convexification of a vehicle motion planning and obstacle avoidance problem as an optimization problem that is then simplified/convexified in such a way that the problem can be solved tractably and in real time by existing methods. This formulation includes obstacles that can vary in size and shape over time, a vehicle model that ensures feasibility of trajectories, and an objective function that ensures comfort, and efficient satisfaction of a goal.

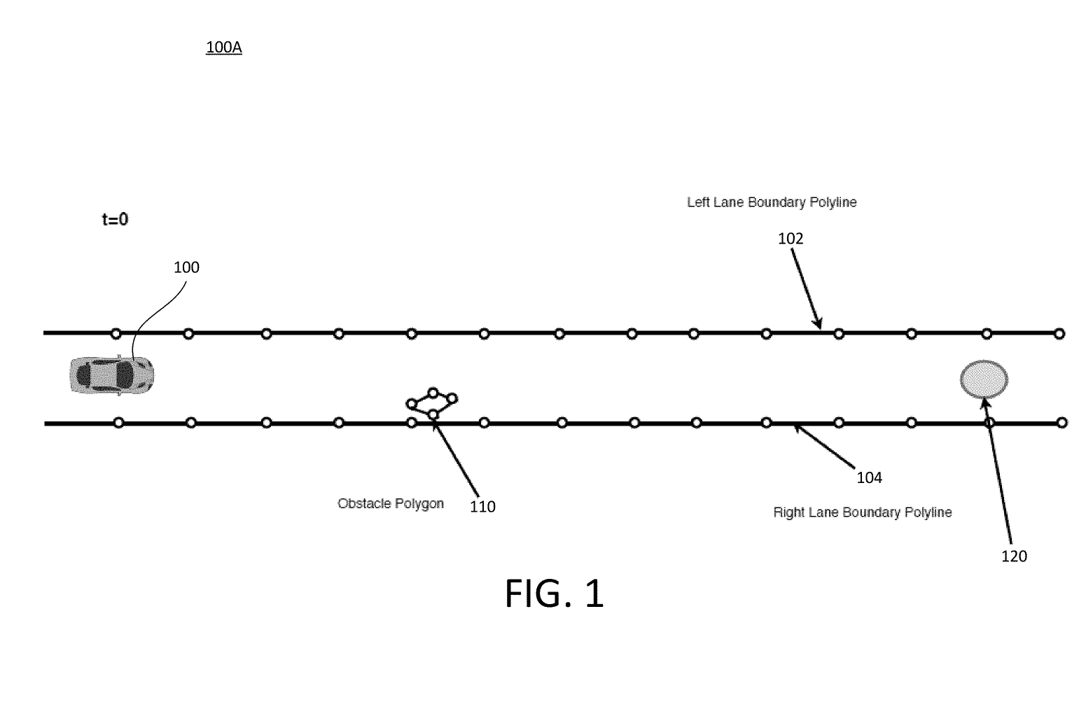

FIG. 1 illustrates an example diagram 100A including a vehicle 100, an obstacle 110 (also referred to as an obstacle polygon), and a goal 120 (also referred to as a target, a target goal, a location, a target location, etc.), according to examples of the disclosure. FIG. 1 also includes a left lane boundary 102 and a right lane boundary 104 (also referred to as a left lane boundary polygon and a right lane boundary polygon, respectively). In addition, FIG. 1 illustrates an example obstacle 110 where time (t)=0.

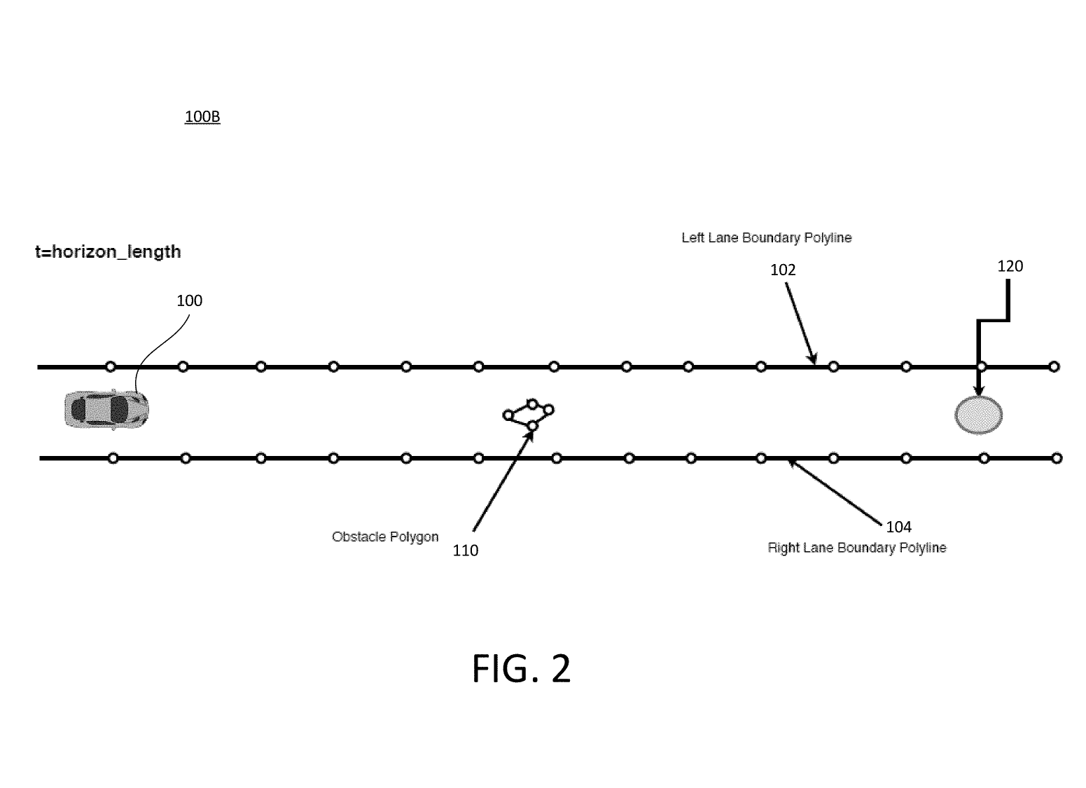

FIG. 2 illustrates an example diagram 100B including a vehicle 100, an obstacle 110 (also referred to as an obstacle polygon), and a goal 120 (also referred to as a target, a target goal, a location, a target location, etc.), according to examples of the disclosure. FIG. 2 also includes a left lane boundary 102 and a right lane boundary 104 (also referred to as a left lane boundary polygon and a right lane boundary polygon, respectively). In addition, FIG. 2 illustrates an example obstacle 110 where time (t)=horizon_length. In various embodiments, horizon_length refers to an amount of time that a decision maker or a motion planner plans ahead.

### Sequential Quadratic Programming

Broadly, motion planning can be posed as an optimization problem. This involves optimizing over the trajectory and/or velocity plans in such a way to minimize a cost function and satisfy constraints. The cost function may include terms such as numerical representations of comfort (e.g. acceleration or jerk magnitude), and terms that are numerical representations of satisfaction of goals, such as distance to a goal pose. The constraints of an optimization problem applied to motion planning may include physical constraints such as maximum feasible or allowable acceleration, how a vehicle might move between poses, or ensuring a minimum distance from obstacles is maintained.

A general optimization problem with m inequality constraints and n equality constraints has the following form:

$$\begin{matrix} {min}_{θ} & f ( θ ) & & \\ subject to & {g}_{i} ( θ ) & \leq 0 & i = 1 ⋯ m \\ & {h}_{j} ( θ ) & = 0 & j = 1 ⋯ n\end{matrix} \qquad ( Equation 1 )$$

with optimization vector θ∈ [symbol] ^{N}.

In this most general form, there are no constraints on the form of the optimization objective, nor on any of the constraints (e.g., these functions need not be affine nor quadratic nor convex).

In various embodiments, the goal of Sequential Quadratic Programming (SQP) is to locally approximate a (nonconvex or nonlinear) optimization problem as a tractable Quadratic Program (QP) and repeatedly solve to get ‘steps’ in θ-space towards a locally optimal solution.

The pseudo-code for solving an optimization problem using SQP can then become:

$$\begin{matrix}Set initial guess {θ}_{0} & ( Equation 2 ) \\ Repeat until ‖ θ - {θ}_{0} ‖ > ϵ \\ Solve \text{:} & ( Equation 3 ) \\ \begin{matrix} {min}_{θ} & ∇ f ( {θ}_{0} ) ( θ - {θ}_{0} ) + \frac{1}{2} {( θ - {θ}_{0} )}^{T} H ( f ) ( {θ}_{0} ) ( θ - {θ}_{0} ) & & \\ Subject To & {g}_{i} ( {θ}_{0} ) + ∇ {{g}_{i} ( {θ}_{0} )}^{T} ( θ - {θ}_{0} ) & \leq 0 & i = 1 … m \\ & {h}_{j} ( {θ}_{0} ) + ∇ {{h}_{j} ( {θ}_{0} )}^{T} ( θ - {θ}_{0} ) & = 0 & j = 1 … n\end{matrix} & ( Equation 4 ) \\ {θ}_{0} ← θ & ( Equation 5 )\end{matrix}$$

where the objective function now becomes the second-order approximation of the objective function about a point θ₀, and the constraints become a ne (linear+bias) approximations also about point θ₀.

In some embodiments, a constraint is added to the size of the update (e.g., L_{∞} norm), and a line search can be performed after each solve iteration on the update size parameter to determine if the true objective function is actually improving (and if not, in some embodiments, the size step constraints may be increased).

Another extension of the SQP paradigm can include Sl1QP, that is sequential quadratic programming with l1 penalties in the place of nonlinear constraints. Concretely, the convex subproblem looks like:

$$\begin{matrix} {min}_{θ , v , w , t} & ∇ f ( {θ}_{0} ) ( θ - {θ}_{0} ) + \frac{1}{2} {( θ - {θ}_{0} )}^{T} {∇}_{θθ}^{2} ℒ ( {θ}_{0} ) ( θ - {θ}_{0} ) + & & & \\ & μ {\sum }_{i = 1}^{m} {t}_{i} + μ {\sum }_{j = 1}^{n} ( {v}_{j} + {w}_{j} ) & & & \\ Subject To & {g}_{i} ( {θ}_{0} ) + ∇ {{g}_{i} ( {θ}_{0} )}^{T} ( θ - {θ}_{0} ) & \geq & - {t}_{i} & i = 1 … m \\ & {h}_{j} ( {θ}_{0} ) + ∇ {{h}_{j} ( {θ}_{0} )}^{T} ( θ - {θ}_{0} ) & = & {v}_{j} - {w}_{j} & j = 1 … n \\ & v , w , t & \geq & 0 & \\ & \vert θ - {θ}_{0} \vert & & s & \end{matrix} \qquad ( Equation 6 )$$

where μ a is the penalty weight, s is the parameter controlling size of the trust region, v, w and t are slack variables and [symbol] is the lagrangian:

[symbol]

=f(θ)−\vec{λ}^{T}\vec{g}(θ)−\vec{v}^{T}\vec{h}(θ) (Equation 7)

As μ increases in magnitude, the constraints will necessarily be satisfied, similar to the steps used in the interior point method. Specifically, this method modifies the objective function to become the following:

$$\tilde{f} ( θ ) = f ( θ ) + {\sum }_{i = 1}^{n} max ( - {g}_{i} ( θ ) , 0 ) + μ {\sum }_{j = 1}^{m} \vert {h}_{j} ( θ ) \vert \qquad ( Equation 8 )$$

And the prior form of the optimization function is simply a modification to handle the nonlinear forms of the absolute value and max functions.

### TrajOpt (Also Known as Trajectory Optimization)

In various embodiments, the TrajOpt algorithm, which can be generated by the motion planner, can be thought of as motion planning formulated as a Sl1QP using obstacle/contact constraints.

Key to the TrajOpt algorithm is the notion of signed distances, a variant on minimum translation distance. The signed distance is negative when objects intersect (the vector and magnitude being the distance between the closest points). This value can be positive when objects are not touching. Signed distance between two convex polygon objects, P and Q is denoted sd(P(θ), Q), where we typically let P(θ) be the robot (vehicle's) polygon (e.g., a polygon representing a vehicle) given a solution and Q be the obstacle polygon.

Calculating the signed distance is a nonlinear operation, and thus can be linearized in the following form:

sd(P(θ),Q)≈sd(P(θ₀),Q)+\hat{n}^{T}Jₚ(θ₀)(θ−θ₀)) (Equation 9)

where \hat{n} is the normal of the minimum translation distance (from the car polygon, P to the obstacle polygon, Q), and Jₚ is the robot jabobian with respect to point p on the car polygon, P.

Recall that given a mapping from configuration space to physical space, [symbol] (θ) [symbol] χ, then the robot jacobian is then defined as:

$${J}_{p} ( θ ) = [ \frac{\partial {f}_{i}}{\partial {θ}_{j}} ] \qquad ( Equation 10 )$$

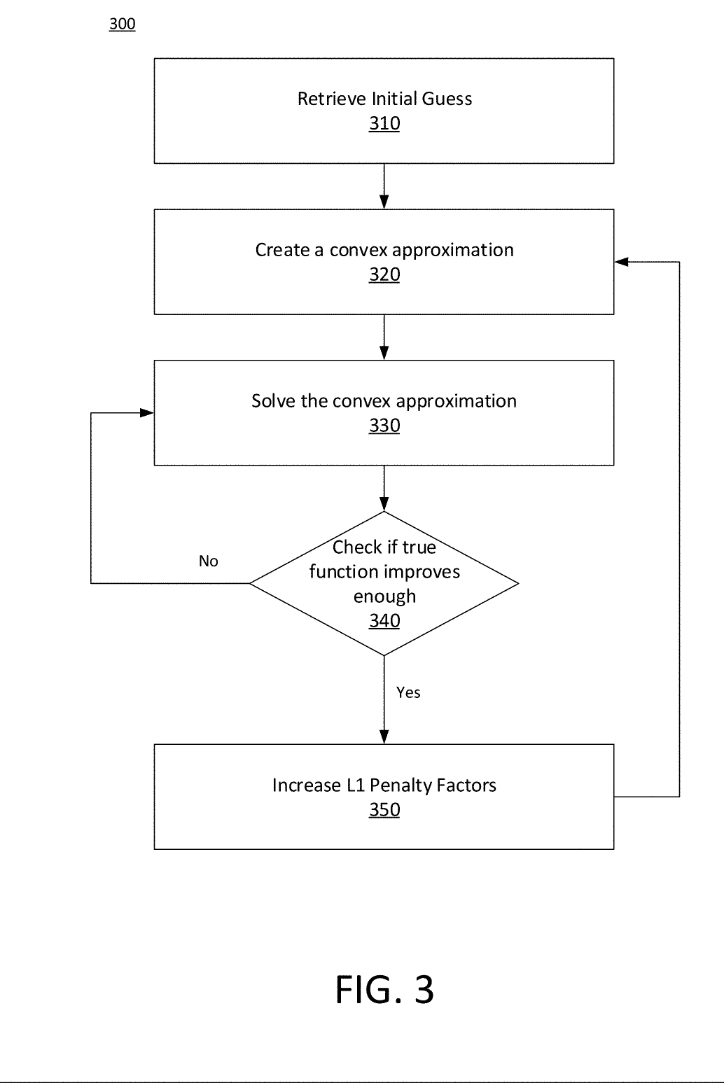

The main loop of the algorithm is described in FIG. 3.

FIG. 3 illustrates an example process for motion planning, according to examples of the disclosure.

At step 310, the initial guess is θ.
This initial guess may be created as a concatenated vector of the vehicle's current pose—that is an initial trajectory assuming the vehicle remains still
The initial guess may also be the last valid trajectory the solver has generated, modified in such a way to be consistent with the vehicle's current pose and goals

At step 320, a convex approximation of a problem with a guess of θ is created.
Nonlinear constraints can be turned into L1 penalties in the objective function.
Slack variables for the nonlinear constraints are also introduced (2 for each equality constraint, 1 for each inequality constraint).
The change from the current guess is bounded to be at most s.

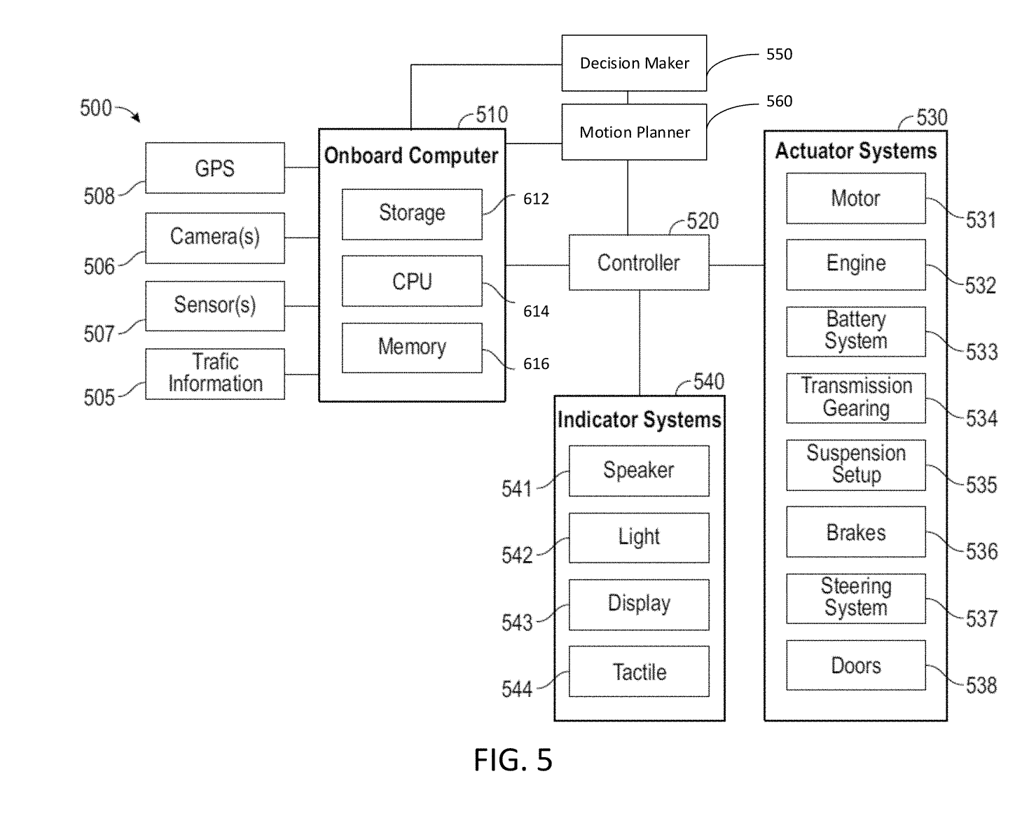

At step 330, the convex approximation is solved (e.g., process 500 of FIG. 5).

At step 340, a determination is made as to whether the true objective function improves enough with regard to the convex approximation. If true, the trust region variables are updated appropriately.
If the improvement is good enough, accept update to θ←θ+d, and expand the trust region: s←τ+S. Proceed to step 350.
Otherwise, return to step 330 with a smaller trust region s←τ−s (line search).

At step 350, the L1 penalty factors are increased, and the process returns to step 320. In some embodiments, the process may stop at a predetermined timeout.

In some embodiments, if the convex subproblem is solved satisfactorily, the L1 penalty factors are increased: μ←k μ, and the method returns to step 320 until it timeout or all constraints are satisfied within a threshold (e.g., within some ∈ tolerance).

### Waypoint Following Motion Planning

As described herein, a motion planner is capable of following waypoints (e.g., traveling to locations/points which may include a target goal). In some embodiments, the waypoint following provided by a motion planner can be defined as a trajectory optimization problem. Such a formulation of the goal in these embodiments allows for a generic interface to the motion planner from other systems, which may include user interfaces or higher level decision making software.

First, in various embodiments, the state variables are defined to be:

$$\begin{matrix}x = {[ E , N , ψ , {u}_{x} , {a}_{x} , {δ}_{rw} ]}^{T} & ( Equation 11 ) \\ u = {[ {j}_{x} , {\dot{δ}}_{rw} ]}^{T} & ( Equation 12 )\end{matrix}$$

Specifically, these state variables are position of the center of gravity, heading of the vehicle, longitudinal velocity and acceleration, road wheel angle, longitudinal jerk, and the time derivative of the road wheel angle.

We can let the full state (at a given time step) be defined as z=[x, u]. Note that the following are equivalent: N≡y_{c}, E≡x_{c}, and that the equations of motion assume that heading, ψ, is CCW positive with North (the positive y-axis) as 0.

Given a time horizon, T (such that t∈[0,T]), discretized in some way such that tₗ=Σ_{τ=0}^{l}Δt_{τ}=T. Here, l∈{1, . . . , L} can be thought of as the index of the state variables for a given time step.

The full optimization vector can now be defined as follows:

θ=[z₁ . . . z_{L}]T∈ [symbol] ^{8·L} (Equation 13)

In some embodiments, the following constraints may also be introduced:
Initial conditions: z₁=zᵢₙᵢₜ
Bounds constraints: z_{lb} [symbol] z₁ [symbol] z_{ub}∀l∈{1,L}
Obstacle constraints: sd(P(zₗ),Q_{k,l})>d_{safe,k}l∈{1,L},∀k∈Kₗ
Dynamic (equality constraints): xₗ₊₁=f(xₗ,uₗ)∀l∈{1,L}

### Obstacle Constraints

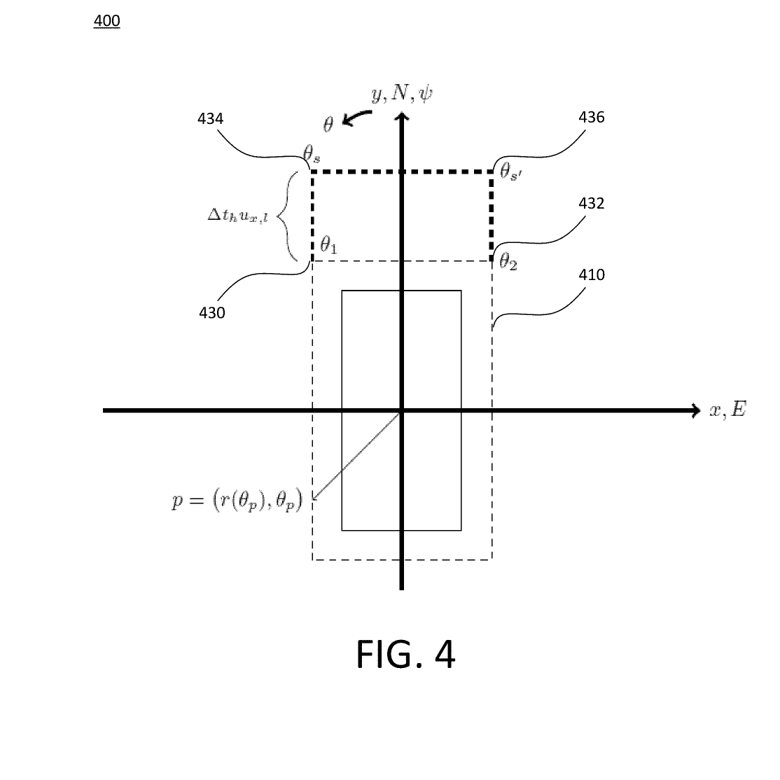

FIG. 4 illustrates an example diagram 400 of a vehicle polygon 410, according to examples of the disclosure. We seek for the vehicle to not collide with any obstacles for each time step. Modeling collisions as violating inequality constraints allows obstacle avoidance to be incorporated into the motion planning optimization problem. We now introduce the following notation:

Let Q_{k,l}k∈{1, . . . , K} refer to a convex obstacle polygon (with points q∈Q_{k,l}), whose position and orientation is predicted at some timestep l. We then require the AV polygon to have some minimum safety distance from each polygon at each timestep l.

For generality, we assume each polygon, Qₖ is given some category (e.g., car, truck, pedestrian, bicycle, etc.). We also assume that each polygon category has some safety distance unique to it. For example, the safety distance for pedestrians might be greater than that of bicycles, and bicycles greater than trucks, which is greater than cars.

Similarly P(zₗ) refers to the bounding box of the vehicle at some timestep l, including some velocity-dependent safety headway added in to the front of the polygon. For concreteness, the vehicle polygon is parameterized by xₗ, yₗ, ψₗ, and u_{x,l}.

### Vehicle Model

A vehicle model can be used in order to provide an approximation of how a vehicle might move. In various embodiments, incorporating such a model into the optimization problem ensures dynamic feasibility, meaning that a trajectory and/or velocity plan generated by the optimization problem will be physically possible to drive.

These values are not explicitly encoded as constraints, but rather are used in the objective function. These values come from the steady state turning assumption.

$$\begin{matrix}{a}_{y} = \frac{{δ}_{rw}}{\frac{L}{{u}_{x}^{2}} + \frac{K}{g}} & ( Equation 14 ) \\ \dot{ψ} = \frac{{δ}_{rw}}{\frac{L}{{u}_{x}} + \frac{{Ku}_{x}}{g}} & ( Equation 15 ) \\ {u}_{y} = - \frac{{W}_{r}}{{gC}_{ar}} {a}_{y} {u}_{x} + b \dot{ψ} & ( Equation 16 ) \\ \dot{x} = - {u}_{x} sin ( ψ ) - {u}_{y} cos ( ψ ) & ( Equation 17 ) \\ \dot{y} = {u}_{x} cos ( ψ ) - {u}_{y} sin ( ψ ) & ( Equation 18 )\end{matrix}$$

where L is the wheelbase length, K is the steering gradient, Cₐᵣ is the rear tire cornering stiffness, Wᵣ is the rear weight distribution, and b is the distance from the center of gravity to the rear axle. Each of these values is car specific, and time invariant, and thus should simply be constant numbers in the final problem.

### Dynamic Equality Constraints

The above stated vehicle model can be applied to update equations, which more concretely describe which pose a vehicle might move to from one pose and some set of inputs. Using the vehicle model equations described in the above section, dynamic feasibility of outputted trajectories can be ensured.

Broadly, we apply a numerical integration scheme to obtain dynamic constraints. Some direct derivative chains are only time varying, and thus the numerical integration method only results dynamic constraints similar to the taylor expansion form:

$$\begin{matrix}{u}_{x , l + 1} = {u}_{x , l} + {a}_{x , l} Δ {t}_{l} + {j}_{x , l} \frac{Δ {t}_{l}}{2} & ( Equation 19 ) \\ {a}_{x , l + 1} = {a}_{x , l} + {j}_{x , l} Δ {t}_{l} & ( Equation 20 ) \\ {δ}_{rw , l + 1} = {δ}_{rw , l} + {\dot{δ}}_{rw , l} Δ {t}_{l} & ( Equation 21 )\end{matrix}$$

While these dynamic constraints are linear, the rest of the constraints can be nonlinear functions of these:

ψ(t)=f(uₓ(t),δ_{rw}(t)) (Equation 22)

a_{y}(t)=f(δ_{rw}(t),uₓ(t)) (Equation 23)

u_{y}(t)=f(a_{y}(t),uₓ(t),ψ(t)) (Equation 24)

\dot{x}(t)=f(uₓ(t),u_{y}(t),ψ(t)) (Equation 25)

\dot{y}(t)=f(uₓ(t),u_{y}(t),ψ(t)) (Equation 26)

The above defined derivatives can then enable the forward estimates of the following optimization variables using a numerical integration scheme, one such example of which will be described in the next section.

ψ(t)=f(ψ(t)) (Equation 27)

x(t)=f(\dot{x}(t)) (Equation 28)

y(t)=f(\dot{y}(t)) (Equation 29)

### Computing the Dynamic Constraints

In some embodiments, first order midpoint updates to compute the linearized equality constraints may be used. In some embodiments, the following true equalities may be obtained:

$$\begin{matrix}ψ ( {t}_{l + 1} ) - ψ ( {t}_{l} ) = \frac{Δ {t}_{l} {\tilde{δ}}_{rw , l}}{\frac{K}{g} + \frac{L}{{\tilde{u}}_{x , l}}} & ( Equation 30 ) \\ x ( {t}_{l + 1} ) - x ( {t}_{l} ) = - Δ {t}_{l} ( {\tilde{u}}_{x , l} sin ( {\tilde{ψ}}_{l} ) + {\tilde{u}}_{y , l} cos ( {\tilde{ψ}}_{l} ) ) & ( Equation 31 ) \\ y ( {t}_{l + 1} ) - y ( {t}_{l} ) = Δ {t}_{l} {\tilde{u}}_{x , l} cos ( {\tilde{ψ}}_{l} ) - Δ {t}_{l} {\tilde{u}}_{y , l} sin ( \tilde{ψ} ) \\ where & ( Equation 32 ) \\ {\tilde{u}}_{x , l} = \frac{1}{2} {a}_{{x}_{l}} Δ {t}_{l} + \frac{1}{8} {j}_{x , l} Δ {t}_{l}^{2} + {u}_{x , l} & ( Equation 33 ) \\ {\tilde{δ}}_{rw , l} = {δ}_{rw , l} + \frac{1}{2} Δ {t}_{l} {\dot{δ}}_{rw , l} & ( Equation 34 ) \\ {\tilde{u}}_{y , l} = \frac{b {\tilde{δ}}_{rw , l}}{\frac{K}{g} + \frac{L}{{\tilde{u}}_{x , l}}} - \frac{{\tilde{δ}}_{rw , l} {\tilde{u}}_{x , l} {W}_{r}}{{C}_{ar} g ( \frac{K}{g} + \frac{L}{{\tilde{u}}_{x , l}^{2}} )} & ( Equation 35 )\end{matrix}$$

These constraints can be linearized to become consistent with the Sl1QP problem formulation in a later section.

### Objective Function

A numerical representation of the goodness of a trajectory is required to make comparisons and thus optimize such a trajectory. This representation can be referred to as an objective function, which may include terms relating to comfort and satisfaction of some goal or goals.

In some embodiments, the objective function may be defined for the optimization problem. Assuming a target goal and a heading of:

W=(N_{w},E_{w},ψ_{w}) (Equation 36)

where w refers to waypoint.

In some embodiments, the objective function can be defined as:

$$F ( θ ) = {\sum }_{l = 1}^{L - 1} \frac{1}{2} ( {{γ}_{{j}_{z}} ( {j}_{x , l} )}^{2} + {{γ}_{{a}_{x}} ( {a}_{x , l} )}^{2} + {{γ}_{{a}_{y}} ( {a}_{y , l} )}^{2} + {{γ}_{δ} ( {δ}_{rw , l} )}^{2} + {{γ}_{δ} ( {\dot{δ}}_{rw , l} )}^{2} + {γ}_{{u}_{x}} U ( {u}_{x , l} , {u}_{x , lim} ) ) + {{γ}_{w , p} ( {N}_{L} - {N}_{w} )}^{2} + {{γ}_{q , p} ( {E}_{L} - {E}_{w} )}^{2} + {γ}_{w , h} atan 2 {( sin ( {ψ}_{w} - {ψ}_{L} ) , cos ( {ψ}_{w} - {ψ}_{L} ) )}^{2} \qquad ( Equation 37 )$$

where U(u,v) is defined as follows:

$$U ( u , v ) = \{ \begin{matrix}{{γ}_{{u}_{+}} ( u - v )}^{2} & u \geq v \\ {γ}_{{u}_{-}} ( v - u ) & u < v\end{matrix} \qquad ( Equation 38 )$$

which is shaped as such to penalize too much velocity (going to fast) more than too little velocity (going to slow).

The a tan 2 expression is used to generate a smooth, differentiable measure of angle difference (e.g., it is used to find |ψ_{w}−ψ_{L}|² without the need to use min, max, and/or modulo.

### Trajectory Optimization Problem Formulation for Vehicle Motion Planning

Below, example jacobians and hessians are defined and used for the convex approximation of an obstacle aware motion planning problem. Solving a motion planning problem is highly nonconvex, and thus very difficult to solve directly. In embodiments of motion planners that directly take into account obstacle information in a closed form, the motion planning problem is even more difficult to solve. A convex optimization problem can be solved more easily. The below example jacobians and Hessians defined provide a template for obstacle aware motion planning to be transformed from a very difficult nonconvex problem into a sequence of easily solved convex problems, the process of which is described generally herein.

### Obstacle Constraints

Solving a combined motion planning and obstacle avoidance problem requires an analytical representation of hitting obstacles or not. Some analytical representations of such can involve polygons (or other shapes such as ellipsoids) representing the vehicle that may change in size, shape, or position over time. The equations for one such example of a polygon representing a vehicle that varies in size is described below. This example of a variable vehicle polygon uses the notion of a time headway to ensure safety and emulate human driving behavior.

Assuming the normal \hat{n}, and the contact points p, and q are given, we now obtain the expression for the robot (e.g., vehicle) jacobian given a contact point.

Notation described herein can be as follows: assuming there is some fixed reference point for the vehicle polygon (e.g., the vehicle represented as a polygon), P, denoted p_{c}=(x_{c},y_{c}). Note that this point can also be the (E, N) that may be backed out at each timestep of the solution of the QP, zₗ∈θ.

The contact point on the surface of P, may also be defined, denoted as p=(xₚ,yₚ).

To fully define an arbitrary point on the surface of the vehicle polygon for any heading, the following “robot/vehicle motion” equations may be used:

xₚ=f₁(zₗ)=x_{c}−rₚ(θₚ,u_{x,l})sin(ψ+θₚ) (Equation 39)

yₚ=f₂(zₗ)=y_{c}−rₚ(θₚ,u_{x,l})cos(ψ+θₚ) (Equation 40)

where (rₚ,θₚ) fully defines any point on the surface of the vehicle polygon and rₚ is a function of θₚ and u_{x,l} because the front of the vehicle polygon expands due to time headway. Additionally, in some embodiments, the following points (in the θ sense) may be defined as follows:
θ₁: The front left-most corner of the nominal vehicle polygon 430.
θ₂: The front right-most corner of the nominal vehicle polygon 432.
θₛ: The left-most corner of the headway expanded vehicle polygon 434.
θ_{s′}: The right-most corner of the headway expanded vehicle polygon 436.

In some embodiments, if θₚ as shown in diagram 400 is in the region where the vehicle polygon varies due to time headway, the expression may be:

$$\begin{matrix}r ( {θ}_{p} , {u}_{x} ) = \{ \begin{matrix}\sqrt{( {w ( {θ}_{p} )}^{2} + {( L + {u}_{x} Δ {t}_{h} )}^{2}} & {θ}_{p} ∈ ( {θ}_{s} , {θ}_{{s}^{′}} ) \\ \sqrt{{w}^{2} + {( L + {L}^{′} ( {θ}_{p} ) )}^{2}} & {θ}_{p} ∈ ( {θ}_{1} , {θ}_{s} ) ⋃ ( {θ}_{{s}^{′}} , {θ}_{2} )\end{matrix} & ( Equation 41 ) \\ {L}^{′} ( {θ}_{p} ) = ( w - w ( {θ}_{p} ) ) tan ( atan 2 ( L , w ( {θ}_{p} ) ) ) & ( Equation 42 )\end{matrix}$$

where the first case corresponds to a point on the front surface, and the second case corresponds to points on the lateral surfaces.

The robot/vehicle jacobian may now be:

$$\begin{matrix}{J}_{p} = [ \begin{matrix}1 & 0 & - {r}_{p} ( {θ}_{p} , {v}_{l} ) cos ( ψ + {θ}_{p} ) & - sin ( ψ + {θ}_{p} ) \frac{\partial r}{\partial {u}_{x}} & ⋯ \\ 0 & 1 & - {r}_{p} ( {θ}_{p} , {v}_{l} ) sin ( ψ + {θ}_{p} ) & cos ( ψ + {θ}_{p} ) \frac{\partial r}{\partial {u}_{x}} & ⋯\end{matrix} ] \\ where & ( Equation 43 ) \\ \frac{\partial r}{\partial {u}_{x}} = \{ \begin{matrix}\frac{Δ {t}_{h} ( L + {u}_{x} {Δt}_{h} )}{r ( {θ}_{p} , {u}_{x} )} & {θ}_{p} ∈ ( {θ}_{s} , {θ}_{{s}^{′}} ) \\ 0 & else \end{matrix} & ( Equation 44 )\end{matrix}$$

In some embodiments, the output of the signed distance geometry functions typically give (xₚ,yₚ) agnostic to the base orientation of the vehicle polygon 410, by transforming the robot/vehicle motion equations, the following simplification may instead be used:

$${\hat{n}}_{k , l}^{T} {J}_{p , k} ( {z}_{l} ) = {\hat{n}}_{k , l}^{T} [ \begin{matrix}1 & 0 & - {y}_{p , k , l} + {y}_{c , l} & - sin ( {ψ}_{l} + {θ}_{p , k , l} ) \frac{\partial r}{\partial {u}_{x , l}} ( {θ}_{p , k , l} ) & ⋯ \\ 0 & 1 & {x}_{p , k , l} - {x}_{c , l} & cos ( {ψ}_{l} + {θ}_{p , k , l} ) \frac{\partial r}{\partial {u}_{x , l}} ( {θ}_{p , k , l} ) & ⋯\end{matrix} ] \qquad ( Equation 45 )$$

where k∈Kₗ is one of the objects at timestep l close enough to the vehicle polygon 410 to warrant a distance check (set Kₗ), and \hat{n}_{k,l} can be the associated normal between the vehicle polygon 410 and the object at that same timestep.

The above can be extended to be over timesteps (e.g., continuous time collision detection). Modifications may include using J_{p,k}(zₗ,zₗ₊₁) instead of the jacobian, the normal can be calculated with respect to the swept volume, and the jacobian for each involved timestep can receive a scaled amount of the jacobian above.

### Objective Jacobian

Convex approximations of generic nonlinear optimization problem require the Jacobian of an objective function to be computed and defined. This section derives the jacobian of the example objective function described above.

The jacobian may have terms relating to the objective function and the distance constraints:

$$\begin{matrix}{J}_{l} = [ \begin{matrix}0 \\ 0 \\ 0 \\ {\dot{U}}_{x} ( {z}_{l} ) \\ {γ}_{{a}_{x , l}} {a}_{x , l} \\ {γ}_{{δ}_{rw , l}} {δ}_{rw , l} + {γ}_{{a}_{y}} \frac{{δ}_{rw , l} {g}^{2} {u}_{x , l}^{4}}{{( {Ku}_{x , l}^{2} + Lg )}^{2}} \\ {γ}_{{j}_{z , l}} {h}_{x , l} \\ {γ}_{{\dot{δ}}_{r , w , l}} {\dot{δ}}_{rw , l}\end{matrix} ] l = 1 … L - 1 \\ where & ( Equation 46 ) \\ {\dot{U}}_{x} ( {z}_{l} ) = {γ}_{{a}_{v}} \frac{2 L {δ}_{rw , l}^{2} {g}^{3} {u}_{x , l}^{3}}{{( {Ku}_{x , l}^{2} + Lg )}^{3}} + \{ \begin{matrix}{γ}_{{u}_{-}} & {u}_{x , l} < {u}_{x , l , limit} \\ {γ}_{{u}_{+}} ( {u}_{x , l} - {u}_{x , l , limit} ) & {u}_{x , l} \geq {u}_{x , l , limit}\end{matrix} & ( Equation 47 )\end{matrix}$$

and the term for the last timestamp is:

$${J}_{L} = [ \begin{matrix}{γ}_{w , p} ( {x}_{c , L} - {x}_{c , w} ) \\ {γ}_{w , p} ( {y}_{c , L} - {y}_{c , w} ) \\ {γ}_{w , h} atan 2 ( sin ( {ψ}_{L} - {ψ}_{w} ) , cos ( {ψ}_{L} - {ψ}_{w} ) ) \\ {\dot{U}}_{x} ( {z}_{L} ) \\ {γ}_{{a}_{x , L}} {a}_{x , L} \\ {γ}_{{δ}_{rw , L}} {δ}_{rw , L} + {γ}_{{a}_{y}} \frac{{δ}_{rw , l} {g}^{2} {u}_{x , l}^{4}}{{( {Ku}_{x , l}^{2} + Lg )}^{2}} \\ {γ}_{{j}_{x , L}} {j}_{x , L} \\ {γ}_{{\dot{δ}}_{rw , L}} {\dot{δ}}_{rw , L}\end{matrix} ] \qquad ( Equation 48 )$$

It should be appreciated that the expression for heading error can be replaced with a min, max, and/or modulo version of angle distance when building these vectors/matrices.

### Dynamic Equality Jacobians

Convex approximations of generic nonlinear optimization problem require the Jacobian of the functions describing constraints to be computed and defined. This section derives the jacobian of the example dynamic equality constraints described in an earlier section.

The following definitions may be useful:

$$\begin{matrix}{\tilde{u}}_{x , l} = \frac{1}{2} {a}_{{x}_{l}} Δ {t}_{l} + \frac{1}{8} {j}_{x , l} Δ {t}_{l}^{2} + {u}_{x , l} & ( Equation 49 ) \\ {\tilde{δ}}_{rw , l} = {δ}_{rw , l} + \frac{1}{2} Δ {t}_{l} {\dot{δ}}_{rw , l} & ( Equation 50 ) \\ {\tilde{u}}_{y , l} = \frac{b {\tilde{δ}}_{rw , l}}{\frac{K}{g} + \frac{L}{{\tilde{u}}_{x , l}}} - \frac{{\tilde{δ}}_{rw , l} {\tilde{u}}_{x , l} {W}_{r}}{{C}_{ar} g ( \frac{K}{g} + \frac{L}{{\tilde{u}}_{x , l}^{2}} )} & ( Equation 51 ) \\ {( \tilde{ψ} )}_{l} = {ψ}_{l} + \frac{Δ {t}_{l} {\tilde{δ}}_{rw , l}}{2 ( \frac{K}{g} + \frac{L}{{\tilde{u}}_{x , l}} )} & ( Equation 52 )\end{matrix}$$

The nonlinear dynamical constraint equations become linearized in the convex subproblem:

$$\begin{matrix} ψ ( {t}_{l} ) + {{J}_{ψ} ( {z}_{l} )}^{T} {z}_{l} - ψ ( {t}_{l + 1} ) = 0 & ( Equation 53 ) \\ x ( {t}_{l} ) + {{J}_{x} ( {z}_{l} )}^{T} {z}_{l} - x ( {t}_{l + 1} ) = 0 & ( Equation 54 ) \\ y ( {t}_{l} ) + {{J}_{y} ( {z}_{l} )}^{T} {z}_{l} - y ( {t}_{l + 1} ) = 0 \\ where & ( Equation 55 ) \\ {J}_{ψ} ( {z}_{l} ) = [ \begin{matrix}0 \\ 0 \\ 0 \\ 8 {d}_{ψ} \\ 4 Δ {t}_{l} {d}_{ψ} \\ \frac{1}{\frac{K}{g} + \frac{L}{{\tilde{u}}_{x , l}}} \\ Δ {t}_{l}^{2} {d}_{ψ} \\ \frac{8 Δ {t}_{l} g {\tilde{u}}_{x , l}}{2 ( 8 K {\tilde{u}}_{l} + 8 Lg )}\end{matrix} ] & ( Equation 56 ) \\ {d}_{ψ} = \frac{{Lg}^{2} {\tilde{δ}}_{rw , l}}{{( K {\tilde{u}}_{x , l} + Lg )}^{2}} & ( Equation 57 ) \\ {J}_{x} ( {z}_{l} ) = [ \begin{matrix}0 \\ 0 \\ Δ {t}_{l} ( - {\tilde{u}}_{x , l} cos ( {\tilde{ψ}}_{l} ) + {\tilde{u}}_{y , l} sin ( \tilde{ψ} ) ) \\ {d}_{x} \\ \frac{Δ {t}_{l}}{2} {d}_{x} \\ - Δ {t}_{l} \frac{{\tilde{u}}_{y , l}^{2}}{{\tilde{δ}}_{rw , l}} cos ( {\tilde{ψ}}_{l} ) \\ \frac{Δ {t}_{l}^{2}}{8} {d}_{x} \\ - Δ {t}_{l}^{2} \frac{{\tilde{u}}_{y , l}^{8}}{2 {\tilde{δ}}_{rw , l}} cos ( {\tilde{ψ}}_{l} )\end{matrix} ] & ( Equation 58 ) \\ {d}_{x} = - Δ {t}_{l} {d}_{u} cos ( {\tilde{ψ}}_{l} ) - Δ {t}_{l} sin ( {\tilde{ψ}}_{l} ) & ( Equation 59 ) \\ {d}_{u} = {\tilde{δ}}_{rw , l} ( \frac{Lb}{{{\tilde{u}}_{x , l}^{2} ( \frac{K}{g} + \frac{L}{{\tilde{u}}_{z , l}} )}^{2}} - \frac{{W}_{r}}{{C}_{ar} g} ( \frac{2 L}{{{\tilde{u}}_{x , l}^{2} ( \frac{K}{g} + \frac{L}{{\tilde{u}}_{x , l}^{2}} )}^{2}} + \frac{1}{\frac{k}{g} + \frac{L}{{\tilde{u}}_{x , l}^{2}}} ) ) & ( Equation 60 ) \\ {J}_{y} ( {z}_{l} ) = [ \begin{matrix}0 \\ 0 \\ Δ {t}_{l} ( - {\tilde{u}}_{x , l} cos ( {\tilde{ψ}}_{l} ) - {\tilde{u}}_{y , l} cos ( \tilde{ψ} ) ) \\ {d}_{y} \\ \frac{Δ {t}_{l}}{2} {d}_{y} \\ - Δ {t}_{l} \frac{{\tilde{u}}_{y , l}^{2}}{{\tilde{δ}}_{rw , l}} sin ( {\tilde{ψ}}_{l} ) \\ \frac{Δ {t}_{l}^{2}}{8} {d}_{y} \\ - Δ {t}_{l}^{2} \frac{{\tilde{u}}_{y , l}^{8}}{2 {\tilde{δ}}_{rw , l}} sin ( {\tilde{ψ}}_{l} )\end{matrix} ] & ( Equation 61 ) \\ {d}_{y} = - Δ {t}_{l} {d}_{u} sin ( {\tilde{ψ}}_{l} ) + Δ {t}_{l} cos ( {\tilde{ψ}}_{l} ) & ( Equation 62 )\end{matrix}$$

The values above can be calculated by using the chain rule (e.g., ignoring the product rule due to inapplicability), for example:

$$\begin{matrix}\frac{\partial F ( \tilde{u} , \tilde{δ} )}{\partial j} = \frac{\partial F ( \tilde{u} , \tilde{δ} )}{\partial \tilde{u}} \frac{\partial \tilde{u}}{\partial j} & ( Equation 63 ) \\ \frac{{\partial }^{2} F ( \tilde{u} , \tilde{δ} )}{\partial j \partial δ} = \frac{{\partial }^{2} F}{\partial \tilde{u} \partial \tilde{δ}} \frac{\partial \tilde{u}}{\partial j} \frac{\partial \tilde{δ}}{\partial δ} & ( Equation 64 )\end{matrix}$$

It may be possible to compute higher order numerical approximations tractably using the chain rule.

### Objective Hessian

Convex approximations of generic nonlinear optimization problem require the Hessians of the objective function to be computed and defined. This section derives the Hessian of the example objective function described in an earlier section.

The hessian of the objective function can be block diagonal for each timestep, and may have the following form:

$$\begin{matrix}{H}_{l} ( {z}_{l} ) = [ \begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & {\tilde{U}}_{x} ( {z}_{l} ) & 0 & {h}_{{u}_{x} , {δ}_{rw}} ( {z}_{l} ) & 0 & 0 \\ 0 & 0 & 0 & 0 & {γ}_{{a}_{x , l}} & 0 & 0 & 0 \\ 0 & 0 & 0 & {h}_{{u}_{x} , {δ}_{rw}} ( {z}_{l} ) & 0 & {γ}_{{δ}_{rw , l}} + {γ}_{{a}_{y}} \frac{{g}^{2} {u}_{x , l}^{2}}{{( {Ku}_{x , l}^{2} + Lg )}^{2}} & 0 & 0 \\ 0 & 0 & 0 & 0 & 0 & 0 & {γ}_{{j}_{x , l}} & 0 \\ 0 & 0 & 0 & 0 & 0 & 0 & 0 & {γ}_{{δ}_{rw , l}}\end{matrix} ] l = 1 … L - 1 \\ where & ( Equation 65 ) \\ {\tilde{U}}_{x} ( {z}_{l} ) = \frac{6 {γ}_{{a}_{y}} {δ}_{rw , l}^{2} {g}^{3} {u}_{x , l}^{2} ( - {Ku}_{x , l}^{2} + Lg )}{{( {Ku}_{x , l}^{2} + Lg )}^{4}} + \{ \begin{matrix}0 & {u}_{x , l} < {u}_{x , l , limit} \\ {γ}_{{u}_{+}} & {u}_{x , l} \geq {u}_{x , l , limit}\end{matrix} & ( Equation 66 )\end{matrix}$$

the first term of which is related to lateral acceleration, and the second term is related to longitudinal velocity penalties. In some embodiments, the other terms for lateral acceleration include:

$${h}_{{u}_{x} , {δ}_{rw}} ( {z}_{l} ) = \frac{{γ}_{{a}_{y}} 4 L {δ}_{rw , l} {g}^{3} {u}_{x , l}^{3}}{{( {Ku}_{x , l}^{2} + Lg )}^{3}} \qquad ( Equation 67 )$$

As described herein, variable ordering can be assumed to be: [x_{c}, y_{c}, ψ, uₓ, aₓ, δ_{rw}, jₓ, \dot{δ}_{rw}]^{T}.

The last block corresponding to timestep L can have a slightly different form due to the final waypoint constraints:

$${H}_{L} ( {z}_{l} ) = [ \begin{matrix}{γ}_{w , p} & 0 & 0 & 0 & 0 & 0 & 0 & 0 \\ 0 & {γ}_{w , p} & 0 & 0 & 0 & 0 & 0 & 0 \\ 0 & 0 & {γ}_{w , h} & 0 & 0 & 0 & 0 & 0 \\ 0 & 0 & 0 & {\tilde{U}}_{x} ( {z}_{L} ) & 0 & {h}_{{u}_{x} , {δ}_{rw}} ( {z}_{l} ) & 0 & 0 \\ 0 & 0 & 0 & 0 & {γ}_{{a}_{x , L}} & 0 & 0 & 0 \\ 0 & 0 & 0 & {h}_{{u}_{x} , {δ}_{rw}} ( {z}_{l} ) & 0 & {γ}_{{δ}_{rw , L}} + {γ}_{{a}_{y}} \frac{{g}^{2} {u}_{x , l}^{2}}{{( {Ku}_{x , l}^{2} + Lg )}^{2}} & 0 & 0 \\ 0 & 0 & 0 & 0 & 0 & 0 & {γ}_{{j}_{x , L}} & 0 \\ 0 & 0 & 0 & 0 & 0 & 0 & 0 & {γ}_{{δ}_{rw , L}}\end{matrix} ] \qquad ( Equation 68 )$$

Most other constraints may be linear and can be passed on directly to the quadratic program (QP). In some embodiments, the nonlinear collision constraint can be linearized, and may not have curvature.

In some embodiments, because the dynamic constraints are being pushed into the objective function, the hessian for these terms are also estimated. This can result in the following (symmetric) hessians:

$$\begin{matrix}{H}_{ψ , l} ( {z}_{l} ) = [ \begin{matrix}0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & \frac{- {KLg}^{2} {δ}_{rw , l}}{{D}_{ψ}^{2}} & \frac{- KL Δ {t}_{l} {g}^{2} {δ}_{rw , l}}{2 {D}_{pm}^{2}} & \frac{{Lg}^{2}}{{D}_{ψ}^{2}} & \frac{- KL Δ {t}_{l}^{2} {g}^{2} {δ}_{rw , l}}{4 {D}_{ψ}^{2}} & \frac{L Δ {t}_{l} {g}^{2}}{2 {D}_{ψ}^{2}} \\ 0 & 0 & 0 & — & \frac{- KL Δ {t}_{l}^{2} {g}^{2} {δ}_{rw , l}}{2 {D}_{ψ}^{2}} & \frac{L Δ {t}_{l} {g}^{2}}{2 {D}_{ψ}^{2}} & \frac{- KL Δ {t}_{l}^{2} {g}^{2} {δ}_{rw , l}}{8 {D}_{ψ}^{2}} & \frac{L Δ {t}_{l}^{2} {g}^{2}}{4 {D}_{≐}^{2}} \\ 0 & 0 & 0 & — & — & 0 & \frac{L Δ {t}_{l}^{2} {g}^{2}}{8 {D}_{ψ}^{2}} & 0 \\ 0 & 0 & 0 & — & — & — & \frac{- KLΔ {t}_{l}^{2} {g}^{2} {δ}_{rw , l}}{32 {D}_{ψ}^{n}} & \frac{L Δ {t}_{l}^{2} {g}^{2}}{16 {D}_{pm}^{2}} \\ 0 & 0 & 0 & — & — & — & — & 0\end{matrix} ] l = 1 … L - 1 \\ where & ( Equation 69 ) \\ {D}_{ψ} = K {\tilde{u}}_{x , l} + Lg & ( Equation 70 ) \\ {H}_{z , l} ( {z}_{l} ) = [ \begin{matrix}0 & 0 & 0 & 0 & 0 & 0 & 0 & 0 \\ 0 & 0 & 0 & 0 & 0 & 0 & 0 & 0 \\ 0 & 0 & {h}_{x , ψ} & {h}_{x , ψ , u} & \frac{1}{2} Δ {t}_{l} {h}_{x , ψ , u} & {h}_{x , ψ , δ} & \frac{1}{8} Δ {t}_{l}^{2} {h}_{x , ψ , u} & \frac{1}{2} Δ {t}_{l} {h}_{x , ψ , δ} \\ 0 & 0 & — & {D}_{x} & \frac{1}{2} Δ {t}_{l} {D}_{x} & {D}_{δ} cos ( {\tilde{ψ}}_{l} ) & \frac{1}{8} Δ {t}_{l}^{2} {D}_{x} & \frac{1}{2} Δ {t}_{l} {D}_{δ} cos ( {\tilde{ψ}}_{l} ) \\ 0 & 0 & — & — & \frac{1}{4} Δ {t}_{l}^{2} {D}_{x} & \frac{1}{2} Δ {t}_{l} {D}_{δ} cos ( {\tilde{ψ}}_{l} ) & \frac{1}{16} Δ {t}_{l}^{3} {D}_{x} & \frac{1}{4} Δ {D}_{δ} cos ( {\tilde{ψ}}_{l} ) \\ 0 & 0 & — & — & — & 0 & \frac{1}{8} Δ {t}_{l}^{2} {D}_{δ} cos ( {\tilde{ψ}}_{l} ) & 0 \\ 0 & 0 & — & — & — & — & \frac{1}{64} Δ {t}_{l}^{4} {D}_{x} & \frac{1}{16} Δ {t}_{l}^{3} {D}_{δ} cos ( {\tilde{ψ}}_{l} ) \\ 0 & 0 & — & — & — & — & — & 0\end{matrix} ] \\ where & ( Equation 71 ) \\ {h}_{x , ψ} = - Δ {t}_{l} {\tilde{u}}_{y , l} cos ( {\tilde{ψ}}_{l} ) + Δ {t}_{l} {\tilde{u}}_{x , l} sin ( {\tilde{ψ}}_{l} ) & ( Equation 72 ) \\ {h}_{x , ψ , u} = - {D}_{δ} sin ( {\tilde{ψ}}_{l} ) - Δ {t}_{l} cos ( {\tilde{ψ}}_{l} ) & ( Equation 73 ) \\ {h}_{x , ψ , δ} = Δ {t}_{l} \frac{{\tilde{u}}_{y , l}}{{δ}_{rw , l}} sin ( {\tilde{ψ}}_{l} ) & ( Equation 74 ) \\ {D}_{u} = K {\tilde{u}}_{x , l}^{2} + Lg & ( Equation 75 ) \\ {D}_{u} = 2 Lg {\tilde{δ}}_{rw , l} Δ {t}_{l} ( \frac{Kbg}{{D}_{ψ}^{3}} - \frac{K {\tilde{u}}_{x , l}^{2} {W}_{r}}{{C}_{ax} {D}_{a}^{3}} + \frac{3 Lg {\tilde{u}}_{x , l} {W}_{r}}{{C}_{ar} {D}_{a}^{3}} ) & ( Equation 76 ) \\ {D}_{x} = {D}_{u} cos ( {\tilde{ψ}}_{l} ) & ( Equation 77 ) \\ {D}_{δ} = Δ {t}_{l} ( \frac{K {\tilde{u}}_{x , l}^{4} {W}_{r}}{{C}_{ar} {D}_{a}^{2}} - \frac{{Lbg}^{2}}{{D}_{ψ}^{2}} + \frac{3 Lg {\tilde{u}}_{x , l}^{2} {W}_{r}}{{C}_{ar} {D}_{a}^{2}} ) & ( Equation 78 ) \\ {H}_{y , l} ( {z}_{l} ) = [ \begin{matrix}0 & 0 & 0 & 0 & 0 & 0 & 0 & 0 \\ 0 & 0 & 0 & 0 & 0 & 0 & 0 & 0 \\ 0 & 0 & {h}_{y , ψ} & {h}_{y , ψ , u} & \frac{1}{2} Δ {t}_{l} {h}_{y , ψ , u} & {h}_{y , ψ , u} & \frac{1}{8} Δ {t}_{l}^{2} {h}_{y , ψ , u} & \frac{1}{2} Δ {t}_{l} {h}_{y , ψ , δ} \\ 0 & 0 & — & {D}_{y} & \frac{1}{2} Δ {t}_{l} {D}_{y} & {D}_{δ} sin ( {ψ}_{l} ) & \frac{1}{8} Δ {t}_{l}^{2} {D}_{y} & \frac{1}{8} Δ {t}_{l} {D}_{δ} sin ( {\tilde{ψ}}_{l} ) \\ 0 & 0 & — & — & \frac{1}{4} Δ {t}_{l}^{2} {D}_{y} & \frac{1}{2} Δ {t}_{l} {D}_{δ} sin ( {\tilde{ψ}}_{l} ) & \frac{1}{16} Δ {t}_{l}^{2} {D}_{y} & \frac{1}{4} Δ {t}_{l}^{2} {D}_{δ} sin ( {\tilde{ψ}}_{l} ) \\ 0 & 0 & — & — & — & 0 & \frac{1}{8} Δ {t}_{l}^{2} {D}_{δ} sin ( {\tilde{ψ}}_{l} ) & 0 \\ 0 & 0 & — & — & — & — & \frac{1}{64} Δ {t}_{l}^{2} {D}_{δ} sin ( {\tilde{ψ}}_{l} ) & 0 \\ 0 & 0 & — & — & — & — & — & 0\end{matrix} ] \\ where & ( Equation 79 ) \\ {h}_{y , ψ} = Δ {t}_{l} {\tilde{u}}_{y , l} sin ( {\tilde{ψ}}_{l} ) - Δ {t}_{l} {\tilde{u}}_{x , l} cos ( {\tilde{ψ}}_{l} ) & ( Equation 80 ) \\ {h}_{y , ψ , u} = {D}_{ψ} cos ( {\tilde{ψ}}_{l} ) - Δ {t}_{l} sin ( {\tilde{ψ}}_{k} ) & ( Equation 81 ) \\ {h}_{y , ψ , δ} = - Δ {t}_{l} \frac{{\tilde{u}}_{y , l}}{{\tilde{δ}}_{rw , l}} cos ( {\tilde{ψ}}_{l} ) & ( Equation 82 ) \\ {D}_{y} = {D}_{u} sin ( {\tilde{ψ}}_{l} ) & ( Equation 83 ) \\ {H}_{e , l} = {H}_{ψ , l} + {H}_{x , l} + {H}_{y , l} & ( Equation 84 )\end{matrix}$$

### Full SQP Subproblem

In some embodiments, the following is the full optimization problem solved at each timestep (e.g., step 330 of process 300).

For brevity, d=θ−θ₀. Further, the objective jacobian and objective hessian may be:

J=[J₁ . . . Jₗ . . . J_{L}] (Equation 85)

H=diag([H₁+H_{e,l} . . . Hₗ+H_{e,l} . . . H_{L}]) (Equation 86)

For clarity, the functions described above may be translated as:

⋅ₗ(θ₀)=[0 . . . 0⋅ₗ(zₗ)0 . . . 0] (Equation 87)

where ⋅ is one of the jacobian expressions derived in the Trajectory Optimization Problem Formulation for Vehicle Motion Planning section, and θ=[z₁ . . . z_{L}].

$$\begin{matrix} {min}_{d} & {J}^{T} d + \frac{1}{2} {d}^{T} Hd + & & \\ & {\sum }_{l = 1}^{L} {\sum }_{k ∈ {K}_{l}} {μ}_{k , l} {l}_{k , l} + & & \\ & {\sum }_{l = 1}^{L - 1} {μ}_{e , l} ( {v}_{x , l} + {w}_{x , l} + {v}_{y , l} + {w}_{y , l} + {v}_{ψ , l} + {w}_{ψ , l} ) & & \\ subject to & {d}_{i} & \leq s & ∀ i ∈ [ 1 , 8 L ] \\ & {d}_{i} & \geq - s & ∀ i ∈ [ 1 , 8 L ] \\ & {z}_{1} - {z}_{init} & = 0 & \\ & {a}_{x , l} + {j}_{x , l} Δ {t}_{l} - {a}_{x , l + 1} & = 0 & l = 1 … L - 1 \\ & {u}_{x , l} + {a}_{x , l} Δ {t}_{l} + \frac{1}{2} {j}_{x , l} Δ {t}_{l}^{2} - {u}_{x , l + 1} & = 0 & l = 1 … L - 1 \\ & {δ}_{rw , l} + {\tilde{δ}}_{rw , l} Δ {t}_{l} - {δ}_{rw , l + 1} & = 0 & l = 1 … L - 1 \\ & {J}_{x , l}^{T} ( {θ}_{0} ) ( d + {θ}_{0} ) + {x}_{l} - {x}_{l + 1} & = {v}_{x , l} - {w}_{x , l} & l = 1 … l - 1 \\ & {J}_{y , l}^{T} ( {θ}_{0} ) ( d + {θ}_{0} ) + {y}_{l} - {y}_{l + 1} & = {v}_{y , l} - {w}_{y , l} & l = 1 … l - 1 \\ & {J}_{ψ , l}^{T} ( {θ}_{0} ) ( d + {θ}_{0} ) + {ψ}_{l} - {ψ}_{l + 1} & = {v}_{ψ , l} - {w}_{ψ , l} & l = 1 … L - 1 \\ & {\hat{n}}_{k , l}^{T} {J}_{{p}_{k , l}} ( {θ}_{0} ) d + sd ( {p}_{k , l} ( {θ}_{0} ) , {q}_{k , l} ) - {d}_{safe , k} & \geq {t}_{k , l} & ∀ k ∈ {K}_{l} , l ∈ [ 1 , L ] \\ & {v}_{\cdot , l} , {w}_{\cdot , l} & \geq 0 & \cdot ∈ \{ x , y , ψ \} , l = 1 … L - 1 \\ & {t}_{k , l} & \geq 0 & ∀ k ∈ {K}_{l} , l = 1 … L \\ {u}_{min} \leq & {u}_{x , l} & \leq {u}_{max} & l = 1 … L \\ {δ}_{min} \leq & {δ}_{rw , l} & \leq {δ}_{max} & l = 1 … L \\ {a}_{x , min} \leq & {a}_{x , l} & \leq {a}_{x , max} & l = 1 … L \\ {δ}_{min} \leq & {\tilde{δ}}_{rw , l} & \leq {\tilde{δ}}_{max} & l = 1 … L \\ {j}_{min} \leq & {j}_{x , l} & \leq {j}_{max} & l = 1 … L \\ {a}_{y , min} \leq & {a}_{u , l} & \leq {a}_{u , max} & l = 1 … L\end{matrix} \qquad ( Equation 88 )$$

where μ's are the L1 penalty weights that are incrementally increased in the outermost loop of the SQP solver. Specifically, μ_{k,l} may be a different weight for different objects (e.g., polylines may be penalized less than vehicles, which may be penalized less than pedestrians), and μ_{e,l} are the weights for the equality constraints, which, for example, may be greater for a smaller l.

The constraints can be summarized (in order) as follows:
Trust region (box) constraint)
Initial conditions
Linear dynamic equality constraints (inherently linear updates)
Linearized collision constraints
Linearized collision constraints
Nonnegativity of slack variables
Constraints on ranges of state variables

In various embodiments, this results in a QP with 8L+6(L−1)+2L+K parameters and 6(L−1) equality constraints and 16L+K+12L inequality constraints, where L is the number of time steps in the horizon, and K is the number of objects present at the current solve. Simplified, the tuple of (# param, # equality constraints, # inequality constraints) becomes: (16L+K−6, 6L−6, 28L+K).

FIG. 5 illustrates an exemplary system block diagram of an autonomous vehicle system including automated driving software according to examples of the disclosure. Vehicle control system 500 can perform automated driving and driving assistance.

System 500 can be incorporated into a vehicle, such as a consumer automobile. Other example vehicles that may incorporate the system 500 include, without limitation, airplanes, boats, motorcycles, robots, or industrial automobiles. Vehicle control system 500 can include one or more cameras 506 capable of capturing image data (e.g., video data) for determining various characteristics of the vehicle's surroundings. Vehicle control system 500 can also include one or more other sensors 507 (e.g., radar, ultrasonic, LIDAR, etc.) capable of detecting various characteristics of the vehicle's surroundings (e.g., to use as scenario parameters of a scenario). For example, sensors 507 can be used for detecting the presence of an object and a distance between the object and the vehicle. Global Positioning System (GPS) receiver 508 capable of determining the location of the vehicle. In some examples, traffic information 505 can be received (e.g., by an antenna) or accessed (e.g., from storage 512 or memory 516), and can be used for determining automated driving routes.

Vehicle control system 500 can include an on-board computer 610 coupled to the traffic information 505, cameras 506, sensors 507, and GPS receiver 508. On-board computer 610 can be capable of receiving one or more of the traffic information, image data from the cameras, outputs from the sensors 507 and the GPS receiver 508. On-board computer 510 can include storage 512, memory 516, and a processor (central processing unit (CPU)) 514. CPU 514 can execute automated driving software stored in storage 512 and/or memory 514. For example, CPU 514 can process the traffic information, image data, sensor outputs and GPS outputs and make driving decisions thereon. For example, processing can include detecting and tracking objects in the environment, tracking vehicle parameters (e.g., odometer, location), navigation planning, lane selection/change planning, motion planning, determining automated driving commands, etc. Additionally, storage 512 and/or memory 516 can store data and instructions for performing the above processing. Storage 512 and/or memory 516 can be any non-transitory computer readable storage medium, such as a solid-state drive, a hard disk drive or a random access memory (RAM) among other possibilities.

The vehicle control system 500 can also include a controller 520 capable of controlling one or more aspects of vehicle operation based on automated driving commands received from the processor. In some examples, the vehicle control system 500 can be connected to (e.g., via controller 520) one or more actuator systems 530 in the vehicle and one or more indicator systems 540 in the vehicle. The one or more actuator systems 530 can include, but are not limited to, a motor 531 or engine 532, battery system 533, transmission gearing 534, suspension setup 535, brakes 536, steering system 537, and door system 538. The vehicle control system 500 can control, via controller 520, one or more of these actuator systems 630 during vehicle operation; for example, to open or close one or more of the doors of the vehicle using the door actuator system 538, to control the vehicle during autonomous driving or parking operations using the motor 531 or engine 532, battery system 533, transmission gearing 534, suspension setup 535, brakes 536 and/or steering system 537, etc. The one or more indicator systems 540 can include, but are not limited to, one or more lights 542 in the vehicle, one or more tactile actuators 544 in the vehicle (e.g., as part of a steering wheel or seat in the vehicle), and/or one or more infotainment systems 545 (e.g., providing entertainment and/or information to the user). The vehicle control system 500 can control, via controller 520, one or more of these indicator systems 640 to provide indications to a user of the vehicle.

In addition, vehicle control system 500 can include a decision maker 550, and a motion planner 560. As described herein, the decision maker 550 and the motion planner 560 may work in conjunction to create a motion plan (e.g., a trajectory and/or velocity). In some embodiments, processes described herein, including processes 300, may be performed by motion planner 560. Also, in some embodiments, decision maker 550 and motion planner 560 may be included in onboard computer 510.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
one or more processors; and
a memory including instructions, which when executed by the one or more processors, cause the one or more processors to perform a method comprising:
receiving a vehicle pose, a target goal, and an obstacle;
deriving constraints from the pose, the target goal, and the obstacle;
convexifying a problem based at least in part on the constraints;
generating a trajectory based at least in part on the convexification of the problem;
causing a vehicle to travel based at least in part on the trajectory.

2. The system of claim 1, wherein the method further comprises:
retrieving an initial guess based on a concatenated vector of the vehicle pose.

3. The system of claim 2, wherein convexifying a problem comprises:
turning nonlinear constraints into penalties in an objective function; and
introducing slack variables for the nonlinear constraints.

4. The system of claim 3, wherein the method further comprises:
determining whether a true objective function improves enough with regard to a result of the convexifying the problem;
if the true objective function improves enough, updating true region variables accordingly; and
if the true objective function does not improve enough, reducing a true region.

5. The system of claim 4, wherein the method further comprises increasing the penalties.

6. The system of claim 1, wherein the method further comprises generating a numerical representation of a goodness of the trajectory.

7. The system of claim 6, wherein the representation comprises an objective function.

8. The system of claim 7, wherein the objective function comprises terms relating to comfort and satisfaction of the target goal.
